(19) United States
(12) Patent Application Publication
(10) Pub. No.: US 2023/0386071 A1
(43) Pub. Date: Nov. 30, 2023

(54) POSITIONING SYSTEM AND POSITIONING METHOD

(71) Applicant: PSJ INTERNATIONAL LTD., Tortola (VG)

(72) Inventors: CHUNG-YUAN CHEN, Tainan City (TW); ALEXANDER I CHI LAI, Taipei City (TW); Ruey-Beei Wu, Taipei City (TW); Chia-yi Chang, Taipei City (TW)

(21) Appl. No.: 17/897,732

(22) Filed: Aug. 29, 2022

(30) Foreign Application Priority Data
May 30, 2022 (TW) 111120025

(51) Int. Cl. G06T 7/73; G06T 7/277

(52) U.S. Cl. CPC G06T 7/73; G06T 7/277

(57) ABSTRACT

A positioning system and a positioning method are provided. The positioning system includes a first positioning device, a second positioning device, a first processing device, and an output device. The first positioning device is used to position a mobile device, and the mobile device contains identification information. The first positioning device generates first positioning information based on the identification information. The second positioning device is used to position an object under test, and the object under test has a feature. The second positioning device generates second positioning information based on the feature. The first processing device generates third positioning information based selectively on the first positioning information and the second positioning information. The output device is used to output the third positioning information.

### CROSS-REFERENCE TO RELATED PATENT APPLICATION

This application claims the benefit of priority to Taiwan Patent Application No. 111120025, filed on May 30, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an information processing system and an information processing method, and more particularly to a positioning system and a positioning method that integrate more than two information sources to perform positioning.

### BACKGROUND OF THE DISCLOSURE

In the conventional positioning technology, an image capturing device can be used to perform image capturing of an object under test that is intended for positioning. Positioning can be performed based on image information, so as to obtain position coordinates and a movement trajectory of the object under test. On the other hand, different information sources can also be used for positioning the object under test. For example, when the object under test holds or carries an identification device, a wireless communication device can also be used to monitor identification information of the identification device. Then, positioning can be performed based on the identification information.

In a positioning method that relies on analysis of the image information, the image capturing device has a high image update frequency and a low positioning error, such that positioning information of the object under test can be quickly updated and is more accurate. However, the image capturing device can only monitor and position the object under test within its field of view, resulting in strict limitations on a positioning range.

On the other hand, in a positioning method that relies on analysis of the identification information, radio frequency signals of the wireless communication device can penetrate through most building barriers, such that a larger positioning range can be provided. However, compared with an image analysis performance of the image capturing device, the wireless communication device has a lower information update frequency and a larger positioning error, rendering such a positioning method less than ideal.

Therefore, those skilled in the art are dedicated to using heterogeneous information sources for positioning purposes. The heterogeneous information sources include image signals that lack the identification information and radio frequency signals that contain the identification information. In this way, advantages of both the image capturing device (i.e., the high image update frequency and the low positioning error) and the wireless communication device (i.e., the large positioning range) can be achieved, so as to further enhance a positioning accuracy.

### SUMMARY OF THE DISCLOSURE

In response to the above-referenced technical inadequacies, the present disclosure provides a positioning system and a positioning method.

In one aspect, the present disclosure provides a positioning system. The positioning system includes a first positioning device, a second positioning device, a first processing device, and an output device. The first positioning device is used to position a mobile device, the mobile device contains identification information, and the first positioning device generates first positioning information based on the identification information. The second positioning device is used to position an object under test, the object under test has a feature, and the second positioning device generates second positioning information based on the feature. The first processing device is used to generate third positioning information based selectively on the first positioning information and the second positioning information. The output device is used to output the third positioning information. The mobile device is attached to the object under test, the first positioning information includes a plurality of position coordinates of the mobile device, and the second positioning information includes a plurality of position coordinates of the object under test. Multiple objects under test can be included in a positioning field, and each of which carries one mobile device.

In another aspect, the present disclosure provides a positioning method. The positioning method includes steps as follows: positioning a mobile device, in which the mobile device contains identification information; generating first positioning information based on the identification information; positioning an object under test, in which the object under test has a feature; generating second positioning information based on the feature; generating third positioning information based selectively on the first positioning information and the second positioning information; and outputting the third positioning information. The mobile device is attached to the object under test, the first positioning information includes a plurality of position coordinates of the mobile device, and the second positioning information includes a plurality of position coordinates of the object under test.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a positioning system according to one embodiment of the present disclosure;

FIG. 2 is a schematic view of a matching mechanism according to one embodiment of the present disclosure;

FIG. 3 is a schematic view showing first positioning information being merged with second positioning information to generate third positioning information according to one embodiment of the present disclosure;

FIG. 4 is a block diagram of the positioning system according to another embodiment of the present disclosure;

FIG. 5 is a schematic view showing the positioning system being used to position a plurality of objects under test according to one embodiment of the present disclosure;

FIG. 6A to FIG. 6D are schematic views showing the first positioning information being merged with the second positioning information to generate the third positioning information according to another embodiment of the present disclosure;

FIG. 7 is a curve diagram showing a cumulative distribution function of an estimation value of the first positioning information of FIG. 6B, a correction value of the first positioning information of FIG. 6C, and the third positioning information of FIG. 6D; and

FIG. 8 is a flowchart illustrating the matching mechanism and merging of positioning information according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

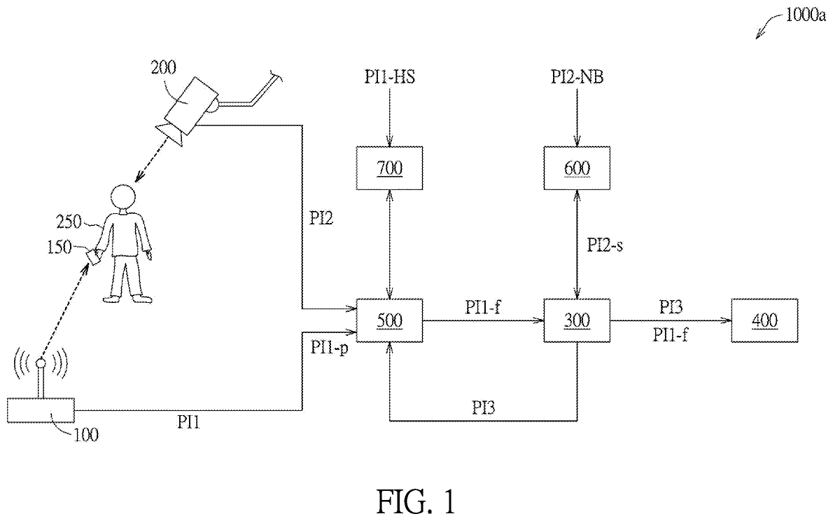

Reference is made to FIG. 1, which is a block diagram of a positioning system 1000a according to one embodiment of the present disclosure. As shown in FIG. 1, the positioning system 1000a includes a first positioning device 100, a second positioning device 200, a first processing device 300, a second processing device 500, a first database 600, a second database 700, and an output device 400. The positioning system 1000a can be used for respective positioning of an object under test 250 and a mobile device 150, so as to obtain position coordinates of the object under test 250 and the mobile device 150 at different time points. Based on these position coordinates, a movement trajectory of the object under test 250 and that of the mobile device 150 can be obtained. In addition, the positioning system 1000a can match and merge the movement trajectories of the object under test 250 and the mobile device 150. The merged movement trajectory has a higher positioning accuracy.

The object under test 250 refers to a moving object (e.g., a living person or animal) or a moving device (e.g., a non-living robot, a small vehicle, and a production machine) that enters a monitoring range of the positioning system 1000a. The mobile device 150 is a handheld device or a portable device that has a wireless communication function, such as a smartphone, a tablet computer, a smartwatch, and a head-mounted device. In the present embodiment, the mobile device 150 is attached to, carried by, or disposed on the object under test 250, or the object under test 250 holds the mobile device 150, so that the mobile device 150 moves with the object under test 250 in a synchronous manner. For example, when the object under test 250 is a person and the mobile device 150 is a smartphone, the smartphone is held by the person and moves in sync with the person.

The mobile device 150 is identifiable for containing unique identification information. The identification information of the mobile device 150 can be, for example, identification codes or identification data. The identification codes can be, for example, a media access control address (MAC address), an international mobile equipment identity (IMEI), and a product serial number. On the other hand, the identification data can be, for example, inertial measurement unit (IMU) sensor data and WI-FI fingerprints.

Communicative transmission is established between the first positioning device 100 and the mobile device 150. During a communicative transmission process, the first positioning device 100 can obtain the identification codes or the identification data of the mobile device 150. For example, the first positioning device 100 is a wireless network base station or a wireless access point (WAP), the mobile device 150 is a smartphone, and the first positioning device 100 obtains the MAC address of the mobile device 150. Then, based on the identification codes or the identification data (e.g., the MAC address) of the mobile device 150, the first positioning device 100 can position the mobile device 150 and obtain first positioning information PI1. This positioning method is referred to as identification positioning, which allows immediate identification of the mobile device 150.

The identification positioning includes an update frequency F_idt and a positioning error E_idt. In one configuration, the first positioning device 100 performs the identification positioning based on the WI-FI fingerprints of the mobile device 150. A WI-FI scan cycle ranges approximately between 3 seconds and 5 seconds. The update frequency F_idt of the identification positioning ranges approximately between 0.2 Hz and 0.33 Hz, and the positioning error thereof is approximately 1 meter. In another configuration, the first positioning device 100 performs the identification positioning based on the WI-FI fingerprints of the mobile device 150 and the IMU sensor data. The update frequency F_idt ranges approximately between 2 Hz and 3.3 Hz, and the positioning error thereof ranges approximately between 0.5 meters and 1 meter.

While the mobile device 150 contains the only identification information and is immediately identifiable, an identity or an attribute of the object under test 250 cannot be immediately identified. That is, the object under test 250 is unidentifiable. The object under test 250 has a feature, such as a body type, a face, or an image feature based on a computer vision algorithm. The positioning system 1000a of the present disclosure does not immediately identify the identity or the attribute of the object under test 250 based on the feature thereof.

The second positioning device 200 monitors the object under test 250. During the monitoring process, the second positioning device 200 can obtain the feature of the object under test 250. In one configuration, the second positioning device 200 is an image capturing device (e.g., an IP network camera), and the object under test 250 is a person. The second positioning device 200 obtains the image feature (e.g., features of an RGB image) of the object under test 250. In another configuration, the second positioning device 200 is a radar or a lidar, and can obtain features of a point cloud of the object under test 250. In a different configuration, the second positioning device 200 is a pyroelectric infrared radial (PIR) sensor, and can obtain features of human body sensing information of the object under test 250. Then, the second positioning device 200 performs positioning of the object under test 250 based on the above-mentioned features of the object under test 250, so as to obtain second positioning information PI2. This positioning method is referred to as non-identification positioning, which does not allow immediate identification of the identity or the attribute of the object under test 250.

The non-identification positioning includes an update frequency F_nidt and a positioning error E_nidt. For example, the second positioning device 200 performs the non-identification positioning based on the image feature of the object under test 250, and an image update frequency is approximately 10 Hz. As such, the update frequency F_nidt of the non-identification positioning is approximately 10 Hz, and the positioning error thereof ranges approximately between 0.03 meters and 0.3 meters.

Generally, the image update frequency of the image capturing device is greater than a WI-FI scan frequency of the wireless access point. Hence, the update frequency F_nidt of the non-identification positioning performed by the second positioning device 200 is greater than the update frequency F_idt of the identification positioning performed by the first positioning device 100. In addition, since an image processing resolution of the image capturing device is greater than a radio-frequency signal processing resolution of the wireless access point, the positioning error E_nidt of the non-identification positioning performed by the second positioning device 200 is smaller than the positioning error E_idt of the identification positioning performed by the first positioning device 100. Moreover, given that the image capturing device cannot view beyond a barrier, and a field of view of the image capturing device is smaller than a radio-frequency signal reception range of the wireless access point, a positioning range R_nidt of the non-identification positioning performed by the second positioning device 200 is smaller than a positioning range R_idt of the identification positioning performed by the first positioning device 100. The positioning system 1000a of the present disclosure can merge the first positioning information PI1 obtained by the first positioning device 100 and the second positioning information PI2 obtained by the second positioning device 200, so that the mobile device 150 matches the object under test 250 and merged positioning information is obtained. In this way, advantages of both the identification positioning (i.e., having the only identification and the positioning range R_idt being larger) and the non-identification positioning (i.e., the positioning error E_nidt being smaller and the update frequency F_nidt being larger) can be realized by the positioning system 1000a of the present disclosure.

When the first positioning device 100 is operated to perform the identification positioning, the first positioning information PI1 is obtained at a current time point t(n), and the first positioning device 100 transmits the first positioning information PI1 to the second processing device 500. Before being processed by the second processing device 500, the first positioning information PI1 includes an estimation value PI1-p that has an error. The estimation value PI1-p can also be referred to as a prediction value. On the other hand, the second database 700 stores a history PI1-HS of the first positioning information PI1. The history PI1-HS of the first positioning information PI1 can be, for example, a plurality of position coordinates that reflect positioning of the mobile device 150 at previous time points t(1), t(2), . . . , t(n−1). Based on the history PI1-HS of the first positioning information PI1, the second processing device 500 can correct the estimation value PI1-p of the first positioning information PI1, so as to obtain a correction value PI1-f of the first positioning information PI1. For example, the second processing device 500 can include a motion filter. Based on the history PI1-HS of the first positioning information PI1, the motion filter performs a motion filtering and smoothing operation on the estimation value PI1-p of the first positioning information PI1, so that the estimation value PI1-p of the first positioning information PI1 is corrected into the correction value PI1-f of the first positioning information PI1. That is, based on the position coordinates that reflect positioning of the mobile device 150 at the previous time points t(1), t(2), . . . , t(n−1), the second processing device 500 performs the motion filtering and smoothing operation on the estimation value PI1-p of the first positioning information PI1 at the current time point t(n), so as to obtain the correction value PI1-f of the first positioning information PI1 at the current time point t(n). The correction value PI1-f can also be referred to as a filtered value. In one configuration, the motion filter of the second processing device 500 can be, for example, a Kalman filter.

On the other hand, the first database 600 stores a pre-established neighboring group PI2-NB of the second positioning information PI2. The neighboring group PI2-NB of the second positioning information PI2 includes positioning information of alternative objects nb(1), nb(2), . . . , nb(m) that are spatially adjacent to the object under test 250. These alternative objects nb(1), nb(2), . . . , nb(m) can be referred to as neighbors.

The first processing device 300 executes a matching mechanism to analyze a matching degree between the first positioning information PI1 and the alternative object nb(1), nb(2), . . . , nb(m) in the neighboring group PI2-NB. According to the matching degrees, the first processing device 300 selects a match PI2-s that has a highest matching degree from the neighboring group PI2-NB. That is, the selected match PI2-s of the second positioning information PI2 best matches the first positioning information PI1.

The matching mechanism operates in the following manner. Based on a matching loss formula, a matching loss value L(1), L(2), . . . , L(m) for each one of the alternative objects nb(1), nb(2), . . . , nb(m) in the neighboring group PI2-NB is calculated, so as to evaluate a matching score thereof. When the matching loss value L(1), L(2), . . . , L(m) is lower, the corresponding matching score is higher. For example, the matching loss formula is to calculate a distance between the position coordinate of the first positioning information PI1 and that of the alternative object nb(1), nb(2), nb(m) in the neighboring group PI2-NB. The above-mentioned distance calculation includes: returning to N time points to calculate distances of positioning coordinates at previous time points t(n−1), . . . , t(n−N), and then obtaining an average value thereof. A matching loss value L(j) of a jth alternative object nb(j) in the neighboring group PI2-NB can be expressed by Formula (1):

$$\frac{1}{N} \{ {Σ}_{t = n - N}^{t = n - 1} ‖ {P}_{self} ( t ) - {P}_{j} ( t ) ‖ \} . \qquad ( 1 )$$

Here, self P_{self}(t) refers to the position coordinate included in the first positioning information PI1 of the mobile device 150, Pⱼ(t) refers to the position coordinate of the jth alternative object nb(j), t=n-N refers to the previous time point t(n−N), and t=n−1 refers to the previous time point t(n−1).

In Formula (1), the position coordinate of the first positioning information PI1 and those of the alternative objects nb(1), nb(2), nb(m) in the neighboring group PI2-NB can be two-dimensional coordinates or three-dimensional coordinates. As such, the matching loss value L(j) of the jth alternative object nb(j) can be a distance of the two-dimensional coordinate or the three-dimensional coordinate. When the distance between the jth alternative object nb(j) and the position coordinate within a history interval of the first positioning information PI1 becomes smaller, the matching loss value L(j) also becomes smaller (which means that the matching score is higher). In other words, there is a high matching degree between the jth alternative object nb(j) and the first positioning information PI1.

According to the matching mechanism mentioned above, the first processing device 300 selects the match PI2-s that has the highest matching degree from the neighboring group PI2-NB. The match PI2-s can be referred to as a relative. The first positioning information PI1 and the match PI2-s of the second positioning information PI2 can form into the merged positioning information. More specifically, the first processing device 300 merges the correction value PI1-f of the first positioning information PI1 with the match PI2-s of the second positioning information PI2, so as to generate third positioning information PI3. The third positioning information PI3 is the merged positioning information. The third positioning information PI3 can be transmitted to the second processing device 500 for the motion filtering and smoothing operation, and then is transmitted to the output device 400. For example, the output device 400 can be a display screen, which shows the position coordinates and the movement trajectory included in the third positioning information PI3.

In another configuration, when a previous matching result of the first positioning information PI1 and the neighboring group PI2-NB of the second positioning information PI2 is known to the first processing device 300, the first processing device 300 can retrieve the previous matching result and transmit the same to the second processing device 500 for the motion filtering and smoothing operation.

In yet another configuration, when no matching result (for matching the first positioning information PI1) can be obtained from the neighboring group PI2-NB of the second positioning information PI2, the first processing device 300 can transmit the correction value PI1-f of the first positioning information PI1 to the output device 400.

In different configurations, according to the matching result obtained after execution of the matching mechanism by the first processing device 300, the output device 400 can output the merged third positioning information PI3. Alternatively, the output device 400 can directly output the correction value PI1-f of the first positioning information PI1.

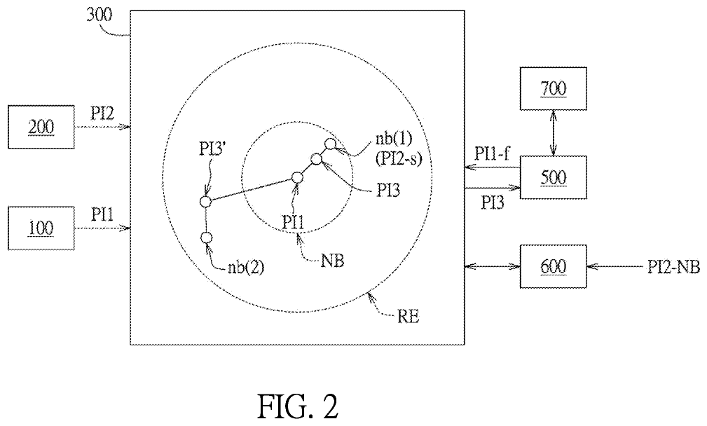

FIG. 2 is a schematic view of the matching mechanism according to one embodiment of the present disclosure. As shown in FIG. 2, the first processing device 300 executes the matching mechanism to analyze the matching degree between the first positioning information PI1 and the alternative object nb(1), nb(2), . . . , nb(m) in the neighboring group PI2-NB of the second positioning information PI2. According to the distance between the position coordinate of the first positioning information PI1 and that of the alternative object nb(1), nb(2), . . . , nb(m), the two alternative objects nb(1) and nb(2) can be determined to fall within a relative area RE (relative to the first positioning information PI1). Further, a minimal distance is defined between the position coordinate of the alternative object nb(1) and the position coordinate of the first positioning information PI1. Based on the matching loss formula (Formula 1), it can be observed that the matching loss value L(1) of the alternative object nb(1) is the smallest. Accordingly, the matching degree between the first positioning information PI1 and the alternative object nb(1) in the neighboring group PI2-NB is determined to be the highest, and the alternative object nb(1) is the match PI2-s of the second positioning information PI2. The alternative object nb(1) falls within a neighbor area NB (relative to the first positioning information PI1). The first positioning information PI1 can be merged into the alternative object nb(1) (i.e., the match PI2-s), so that the third positioning information PI3 is obtained. The merged positioning information obtained based on the new matching result at a current time point is the third positioning information PI3.

On the other hand, the alternative object nb(2) may be the matching result of a previous time point obtained through execution of the matching mechanism. Based on the matching resulting of the previous time point, the alternative object nb(2) can be merged into the first positioning information PI1, so as to obtain a third positioning information PI3′. Therefore, when no new matching result can be obtained at the current time point, and the matching result of the previous time point is already known to the first processing device 300, the third positioning information PI3′ can also be used as the merged positioning information.

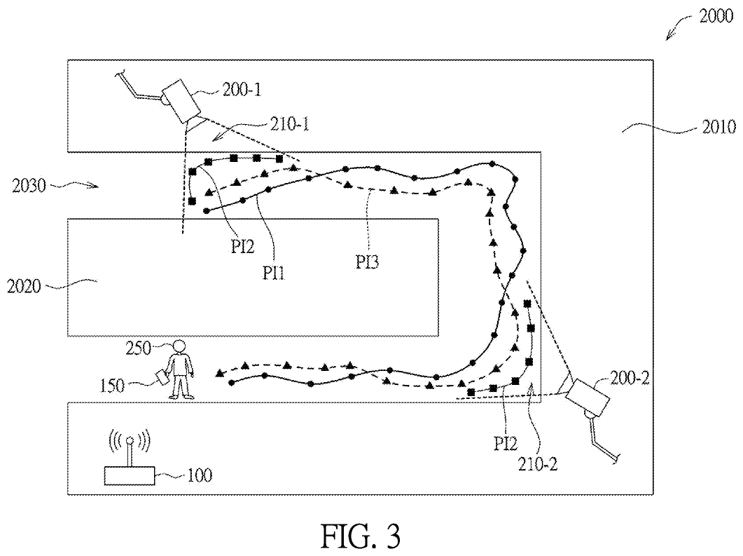

FIG. 3 is a schematic view showing the first positioning information PI1 being merged with the second positioning information PI2 to generate the third positioning information PI3 according to one embodiment of the present disclosure. As shown in FIG. 3, the first positioning device 100 and two second positioning devices 200-1, 200-2 are disposed in a field 2000 for positioning the object under test 250 and the mobile device 150. The field 2000 includes, for example, building bodies 2010, 2020 and a passage 2030. The object under test 250 and the mobile device 150 can move through the passage 2030. The first positioning device 100 performs the identification positioning with respect to the mobile device 150, so as to obtain the first positioning information PI1. The first positioning information PI1 includes the position coordinates of the mobile device 150 at different time points. These position coordinates can be connected into the movement trajectory of the mobile device 150. Through the motion filtering and smoothing operation, the first positioning information PI1 can be processed to obtain the correction value PI1-f (not shown) of the first positioning information PI1.

On the other hand, the two second positioning devices 200-1, 200-2 are disposed at an end and a corner of the building body 2010, respectively. The second positioning device 200-1 has a field of view 210-1, and the second positioning device 200-2 has a field of view 210-2. The second positioning device 200-1 and the second positioning device 200-2 perform the non-identification positioning with respect to the object under test 250 in the field of view 210-1 and the field of view 210-2, respectively, so as to obtain the second positioning information PI2. The second positioning information PI2 includes the position coordinates of the object under test 250 at different time points. These position coordinates can be connected into the movement trajectory of the object under test 250. As shown in FIG. 3, the movement trajectories obtained from the second positioning information PI2 are limited within the field of view 210-1 of the second positioning device 200-1 and the field of view 210-2 of the second positioning device 200-2. The second positioning information PI2 cannot be obtained outside the fields of view 210-1, 210-2.

Then, the first positioning information PI1 and the second positioning information PI2 are selectively merged to form the merged positioning information (i.e., the third positioning information PI3). Alternatively, the third positioning information PI3 can be formed by merging the second positioning information PI2 with the correction value PI1-f of the first positioning information PI1 (which is further obtained through the motion filtering and smoothing operation). In the present embodiment, the first positioning information PI1 and the second positioning information PI2 are merged within the fields of view 210-1, 210-2 of the second positioning devices 200-1, 200-2. Since the second positioning information PI2 cannot be obtained outside the fields of view 210-1, 210-2, the third positioning information PI3 can be obtained merely based on the first positioning information PI1. In other words, the third positioning information is generated based selectively on the first positioning information and the second positioning information.

For example, the first positioning device 100 of the present embodiment is a wireless network access point, and performs the identification positioning based on the MAC address of the mobile device 150. The first positioning information PI1 generated thereby has a larger positioning error E_idt. On the other hand, the second positioning devices 200-1, 200-2 of the present embodiment are image capturing devices, and perform the non-identification positioning based on the image feature of the object under test 250. While the second positioning information PI2 generated thereby has a smaller positioning error E_nidt, a range of the second positioning information PI2 is limited within the fields of view 210-1, 210-2 of the second positioning devices 200-1, 200-2. The merged third positioning information PI3 can cover a larger range and reduce the positioning error.

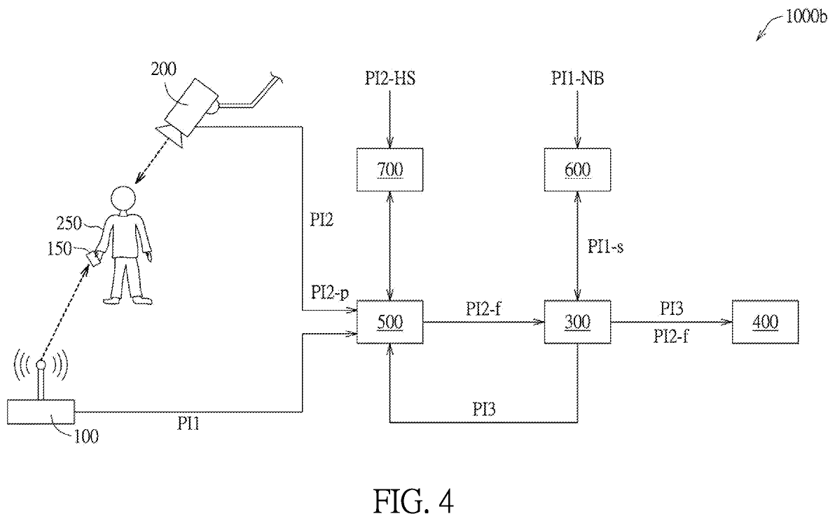

Reference is made to FIG. 4, which is a block diagram of a positioning system 1000b according to another embodiment of the present disclosure. In the present embodiment, the first positioning information PI1 and the second positioning information PI2 of the positioning system 1000b function in a manner opposite to those of the positioning system 1000a of FIG. 1. As shown in FIG. 4, the second positioning device 200 of the positioning system 1000b performs the non-identification positioning to obtain the second positioning information PI2. Compared with the positioning system 1000a of FIG. 1, the second processing device 500 of the positioning system 1000b in the present embodiment receives the second positioning information PI2 (instead of the first positioning information PI1) at the current time point. Before being processed by the second processing device 500, the second positioning information PI2 includes an estimation value PI2-p that has an error. On the other hand, the second database 700 stores a history PI2-HS of the second positioning information PI2. Based on the history PI2-HS of the second positioning information PI2, the second processing device 500 corrects the estimation value PI2-p of the second positioning information PI2, so as to obtain a correction value PI2-f of the second positioning information PI2.

The first database 600 stores a neighboring group PI1-NB of the first positioning information PI1. The first processing device 300 executes the matching mechanism to select a match PI1-s from the neighboring group PI1-NB of the first positioning information PI1. The matching degree between the match PI1-s and the second positioning information PI2 is the highest. Then, the first processing device 300 merges the correction value PI2-f of the second positioning information PI2 with the match PI1-s of the first positioning information PI1 to obtain the third positioning information PI3, and transmits the same to the output device 400.

In another configuration, when no matching result (for matching the second positioning information PI2) can be obtained from the neighboring group PI1-NB of the first positioning information PI1, the first processing device 300 can transmit the correction value PI2-f of the second positioning information PI2 to the output device 400.

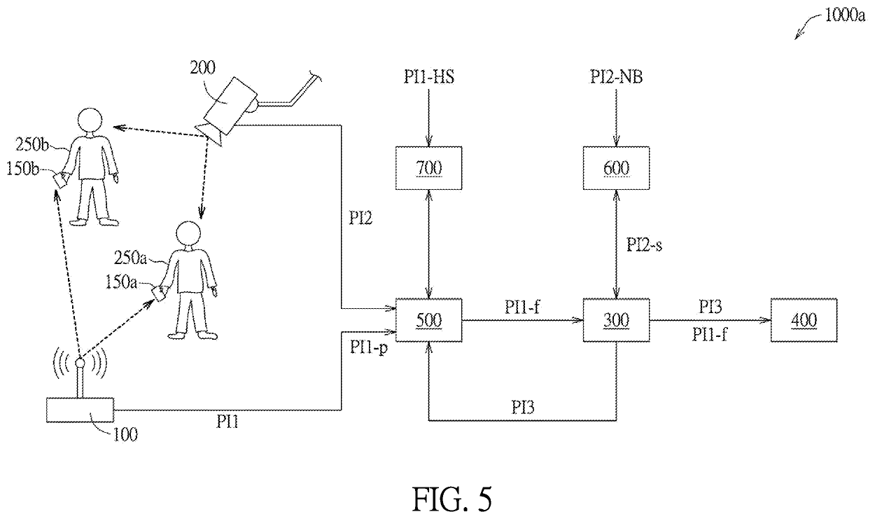

FIG. 5 is a schematic view showing the positioning system 1000a being used to position objects under test 250a, 250b according to one embodiment of the present disclosure. Referring to FIG. 5, when a first object under test (i.e., 250a) enters a field, the second positioning device 200 performs the non-identification positioning with respect to the object under test 250a, so as to obtain the second positioning information PI2. On the other hand, the first positioning device 100 performs the identification positioning with respect to a mobile device 150a (which is held by the object under test 250a), so as to obtain the first positioning information PI1. The positioning system 1000a performs a registration procedure with respect to the mobile device 150a. Then, the first processing device 300 merges the correction value PI1-f of the first positioning information PI1 with the match PI2-s of the second positioning information PI2 for obtaining the third positioning information PI3. The output device 400 can display the third positioning information PI3, which includes the position coordinate at each time point and the movement trajectory formed by connection of these position coordinates. In one configuration, the output device 400 can further display a predetermined map, and project the position coordinates and the movement trajectory included in the third positioning information PI3 onto the predetermined map.

When a second object under test (i.e., 250b) enters the field, the second positioning device 200 performs the non-identification positioning with respect to the object under test 250b, the first positioning device 100 performs the identification positioning with respect to a mobile device 150b (which is held by the object under test 250b), and the positioning system 1000a performs the registration procedure with respect to the mobile device 150b. Through concurrent processing, the positioning system 1000a can separately perform positioning of the first object under test (i.e., 250a) and the second object under test (i.e., 250b) by using different threads of execution.

When the first object under test (i.e., 250a) or the second object under test (i.e., 250b) leaves the field, the positioning system 1000a can perform a de-registration procedure with respect to the mobile device 150a or the mobile device 150b. In addition, the output device 400 removes position coordinates and movement trajectories of the deregistered mobile device 150a or the deregistered mobile device 150b from the predetermined map of the output device 400.

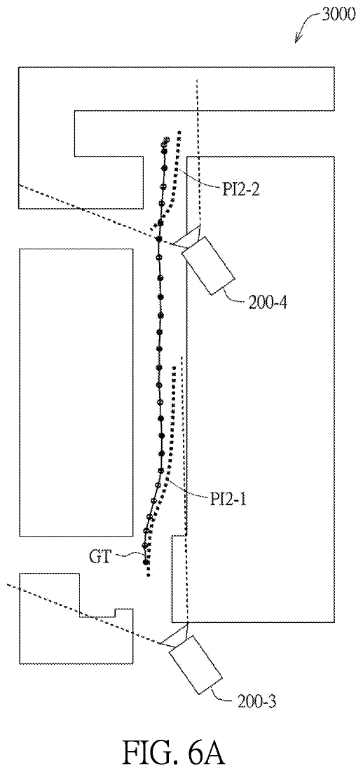

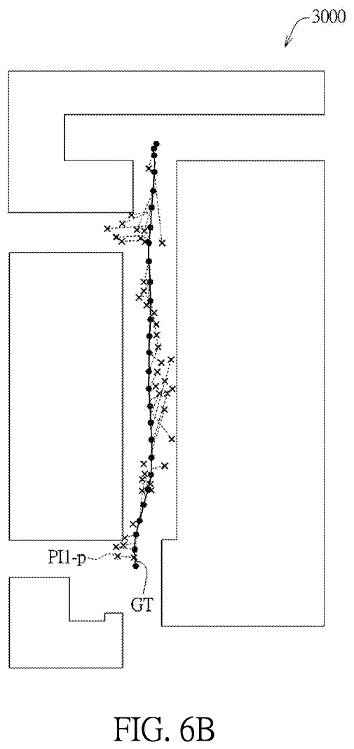

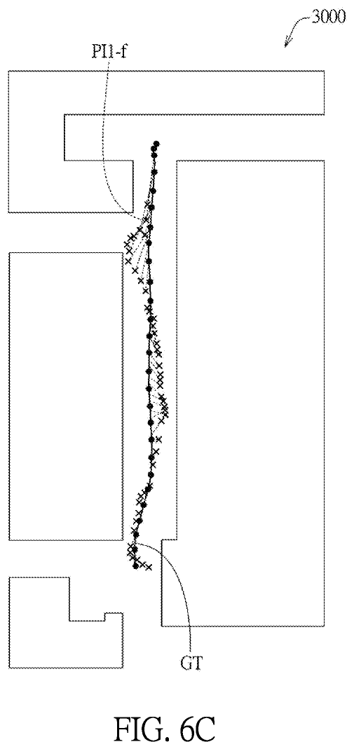

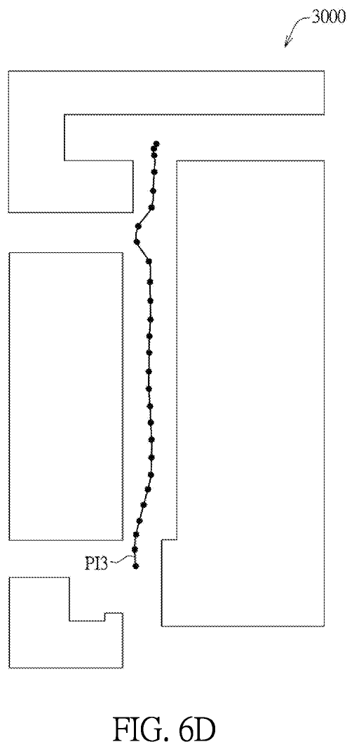

FIG. 6A to FIG. 6D are schematic views showing the first positioning information PI1 being merged with the second positioning information PI2 to generate the third positioning information PI3 according to another embodiment of the present disclosure. Reference is made to FIG. 6A. Two second positioning devices 200-3, 200-4 are disposed in a field 3000. These second positioning devices 200-3, 200-4 perform positioning of an object under test (not shown), so as to respectively obtain second positioning information PI2-1 and seconding positioning information PI2-2. The second positioning information PI2-1 and the seconding positioning information PI2-2 include position coordinates of the object under test at different time points and movement trajectories formed by connection of these position coordinates. Moreover, a ground truth GT in FIG. 6A refers to a positioning reference trajectory, and the positioning reference trajectory is generated by sampling a real trajectory of the object under test with a 360 degrees lidar (not shown in FIG. 6A). The lidar is merely used for experimental and comparison purposes, and is not essential to the positioning system 1000a (or 1000b) of the present disclosure.

Referring to FIG. 6B, the first positioning device 100 (not shown) in the field 3000 performs positioning of a mobile device (not shown) held by the object under test, so as to obtain the estimation value PI1-p of the first positioning information PI1. The estimation value PI1-p of the first positioning information PI1 includes position coordinates of the mobile device at different time points and a movement trajectory formed by connection of these position coordinates. As shown in FIG. 6B, there are some spatial differences between the movement trajectory included in the estimation value PI1-p of the first positioning information PI1 and the movement trajectory of the ground truth GT generated by the lidar.

On the other hand, after the motion filtering and smoothing operation is performed on the estimation value PI1-p of the first positioning information PI1 (as shown in FIG. 6B), the correction value PI1-f of the first positioning information PI1 (as shown in FIG. 6C) can be obtained. Compared with the estimation value PI1-p of the first positioning information PI1 (as shown in FIG. 6B), the movement trajectory included in the correction value PI1-f of the first positioning information PI1 (as shown in FIG. 6C) is spatially corrected, thereby being closer to the movement trajectory of the ground truth GT generated by the lidar.

Further, by merging the correction value PI1-f of the first positioning information PI1 (as shown in FIG. 6C) with the second positioning information PI2-1, PI2-2 (as shown in FIG. 6A), the third positioning information PI3 can be obtained. The third positioning information PI3 is the merged positioning information, and can thus be used for positioning the movement trajectory of the object under test with higher precision.

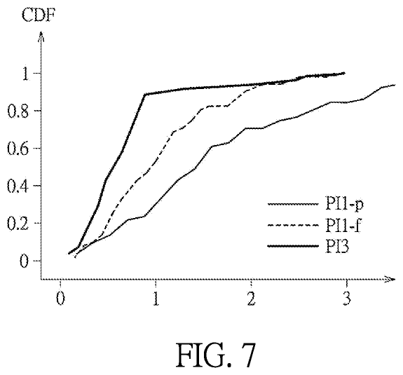

FIG. 7 is a curve diagram showing a cumulative distribution function (CDF) of the estimation value PI1-p of the first positioning information PI1 of FIG. 6B, the correction value PI1-f of the first positioning information PI1 of FIG. 6C, and the third positioning information PI3 of FIG. 6D. As shown in FIG. 7, compared with the estimation value PI1-p of the first positioning information PI1, a cumulative distribution of the correction value PI1-f of the first positioning information PI1 that has undergone the motion filtering and smoothing operation reaches a cumulative probability of 1 (i.e., 100%) more quickly. This indicates that the correction value PI1-f of the first positioning information PI1 can be used for a more accurate positioning of the movement trajectory.

After the correction value PI1-f of the first positioning information PI1 and the second positioning information PI2 are merged, the third positioning information PI3 can be obtained. A cumulative distribution of the third positioning information PI3 reaches the cumulative probability of 1 even more quickly. This indicates that the merged third positioning information PI3 can be used for an even more accurate positioning of the movement trajectory.

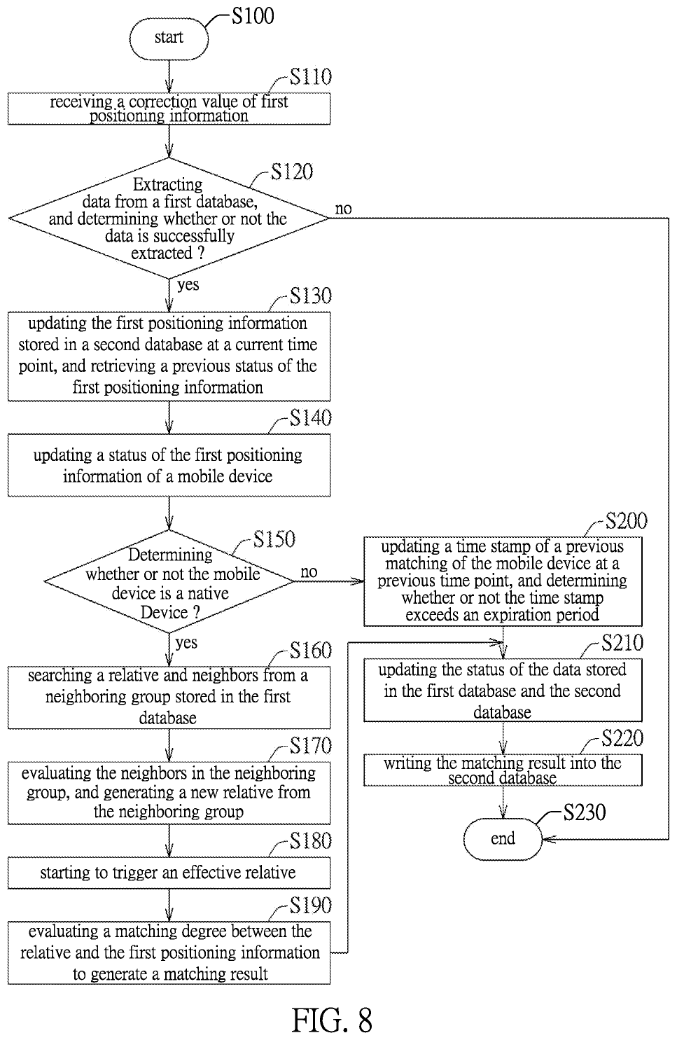

Reference is made to FIG. 8, which is a flowchart illustrating the matching mechanism and merging of positioning information according to one embodiment of the present disclosure. A process starts (step S100). In step S110, the first processing device 300 receives the correction value PI1-f of the first positioning information PI1. The correction value PI1-f of the first positioning information PI1 has already undergone the motion filtering and smoothing operation.

In step S120, the first processing device 300 extracts data from the first database 600, and determines whether or not the data is successfully extracted. If extraction of the data is unsuccessful, the process ends (step S230). If extraction of the data is successful, the process proceeds to step S130. The step S130 includes: updating the first positioning information PI1 stored in the second database 700 at the current time point, and retrieving a previous status of the first positioning information PI1. The first positioning information PI1 can be, for example, the position coordinates of the mobile device 150.

In step S140, a status of the first positioning information PI1 of the mobile device 150 is updated. Then, in step S150, whether or not the mobile device 150 is a native device is determined. When the first positioning information PI1 of the mobile device 150 has yet to match and merge with the second positioning information PI2 of the object under test 250, the mobile device 150 is determined to be the native device. If the mobile device 150 is determined to be the native device, the process proceeds to step S160. The step S160 includes: searching the relative (i.e., a matched combination in the previous limited history) and the neighbors (i.e., native devices that are sufficiently close in distance but have not yet matched) from the neighboring group PI2-NB of the second positioning information PI2 stored in the first database 600.

In step S170, the neighbors in the neighboring group PI2-NB are evaluated, and a new relative is generated from the neighboring group PI2-NB. The step S170 is followed by step S180, which is to start triggering an effective relative. Then, in step S190, the matching degree between the relative in the neighboring group PI2-NB and the first positioning information PI1 is evaluated, and the match PI2-s is selected from the neighboring group PI2-NB based on the matching degree. Further, the match PI2-s is matched with the first positioning information PI1 to obtain the matching result, and the matching result is written into the status of the first positioning information PI1. In one configuration, the matching loss value L(j) between the first positioning information PI1 and the relative (e.g., the jth alternative object nb(j)) in the neighboring group PI2-NB is calculated based on the matching loss formula of Formula (1), so as to evaluate the matching degree.

In continuation of the step S190, step S210 is performed. The step S210 includes: updating the status of the data (i.e., the first positioning information PI1 or the second positioning information PI2) stored in the first database 600 and the second database 700. Afterwards, step S220 is performed. The step S220 includes: writing the matching result (i.e., the match PI2-s in the neighboring group PI2-NB matching the first positioning information PI1) into the history stored in the second database 700.

On the other hand, in the step S150, if the mobile device 150 is determined not to be the native device (i.e., the first positioning information PI1 of the mobile device 150 is already matched and merged with the second positioning information PI2 of the object under test 250 at the previous time point), step S200 is performed. The step S200 includes: updating a time stamp of a previous matching of the mobile device 150 at the previous time point, and determining whether or not the time stamp of the previous matching of the mobile device 150 exceeds an expiration period. In continuation of the step S200, the step S210 (i.e., updating the status of the data stored in the first database 600 and the second database 700) is performed. Afterwards, the step S220 (i.e., writing the matching result into the history stored in the second database 700) is performed.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A positioning system, comprising:
a first positioning device, wherein the first positioning device is used to position a mobile device, the mobile device contains identification information, and the first positioning device generates first positioning information based on the identification information;
a second positioning device, wherein the second positioning device is used to position an object under test, the object under test has a feature, and the second positioning device generates second positioning information based on the feature;
a first processing device being used to generate third positioning information based selectively on the first positioning information and the second positioning information; and
an output device being used to output the third positioning information;
wherein the mobile device is attached to the object under test, the first positioning information includes a plurality of position coordinates of the mobile device, and the second positioning information includes a plurality of position coordinates of the object under test.

2. The positioning system according to claim 1, wherein the second positioning device is an image capturing device, the feature of the object under test is an image feature, and the image capturing device generates the second positioning information based on the image feature.

3. The positioning system according to claim 1, wherein the second positioning information includes a neighboring group, and the first positioning information includes a correction value, the positioning system further comprising:
a first database being used to store the neighboring group of the second positioning information;
wherein the first processing device selects a match from the neighboring group of the second positioning information, the match matches the first positioning information, and the correction value of the first positioning information is merged with the match of the neighboring group, so as to generate the third positioning information.

4. The positioning system according to claim 3, wherein the first processing device is further used to:
calculate, based on a matching loss formula, a matching score for each alternative object in the neighboring group of the second positioning information; and
select, based on the matching score, the match from the neighboring group of the second positioning information.

5. The positioning system according to claim 3, wherein the first positioning information includes an estimation value, the positioning system further comprising:
a second processing device, wherein the second processing device is used to correct the estimation value of the first positioning information, so as to obtain the correction value of the first positioning information.

6. The positioning system according to claim 5, wherein the first positioning information includes a history, the positioning system further comprising:
a second database being used to store the history of the first positioning information;
wherein, based on the history of the first positioning information, the second processing device corrects the estimation value of the first positioning information.

7. The positioning system according to claim 6, wherein the second processing device includes:
a motion filter, wherein the motion filter is used to perform motion filtering based on the history of the first positioning information, so as to obtain the correction value of the first positioning information;
wherein the motion filter is a Kalman filter.

8. The positioning system according to claim 1, wherein the first positioning information includes a neighboring group, and the second positioning information includes a correction value, the positioning system further comprising:
a first database being used to store the neighboring group of the first positioning information;
wherein the first processing device selects a match from the neighboring group of the first positioning information, the match matches the second positioning information, and the correction value of the second positioning information is merged with the match of the neighboring group, so as to generate the third positioning information.

9. The positioning system according to claim 8, wherein the second positioning information includes an estimation value and a history, the positioning system further comprising:
a second database being used to store the history of the second positioning information; and
a second processing device, wherein the second processing device is used to correct the estimation value of the second positioning information based on the history of the second positioning information, so as to obtain the correction value of the second positioning information.

10. A positioning method, comprising:
positioning a mobile device, wherein the mobile device contains identification information;
generating first positioning information based on the identification information;
positioning an object under test, wherein the object under test has a feature;
generating second positioning information based on the feature;
generating third positioning information based selectively on the first positioning information and the second positioning information; and
outputting the third positioning information;
wherein the mobile device is attached to the object under test, the first positioning information includes a plurality of position coordinates of the mobile device, and the second positioning information includes a plurality of position coordinates of the object under test.

11. The positioning method according to claim 10, wherein the feature of the object under test is an image feature, the positioning method further comprising:
generating, based on the image feature, the second positioning information through an image capturing device.

12. The positioning method according to claim 10, wherein the second positioning information includes a neighboring group, and the first positioning information includes a correction value, the positioning method further comprising:
storing the neighboring group of the second positioning information in a first database;
selecting a match from the neighboring group of the second positioning information, wherein the match matches the first positioning information; and
merging the correction value of the first positioning information with the match of the neighboring group, so as to generate the third positioning information.

13. The positioning method according to claim 12, further comprising:
calculating, based on a matching loss formula, a matching score for each alternative object in the neighboring group of the second positioning information; and
selecting, based on the matching score, the match from the neighboring group of the second positioning information.

14. The positioning method according to claim 12, wherein the first positioning information includes an estimation value, the positioning method further comprising:
correcting the estimation value of the first positioning information, so as to obtain the correction value of the first positioning information.
